(19) United States
(12) Patent Application Publication
(10) Pub. No.: US 2007/0127621 A1
(43) Pub. Date: Jun. 7, 2007

(54) Asymmetric csct

(76) Inventors: Michael Grass, Buchholz in der Nordheide (DE); Thomas Koehler, Norderstedt (DE)

Correspondence Address: PHILIPS INTELLECTUAL PROPERTY & STANDARDS, P.O. BOX 3001, BRIARCLIFF MANOR, NY, 10510, US

(21) Appl. No.: 10/575,585

(22) PCT Filed: Oct. 5, 2004
(86) PCT No.: PCT/IB04/51970

§ 371 Date: Apr. 11, 2006

(30) Foreign Application Priority Data
Oct. 14, 2003 (EP) 03103797,1

(51) Int. Cl. H05G 1/60

(52) U.S. Cl. 378/4

(57) ABSTRACT

According to the present invention, an asymmetric acquisition system is used, where the radiation detector is arranged asymmetrically with respect to a fan beam plane of motor the scanner. Advantageously, this may allow to increase a scatter angle range for a given detector height in the direction of the rotational axis. Furthermore, this may allow for an optimal data flow for a combined volume absorption distribution reconstruction and subsequent coherent scatter CT reconstruction.

The present invention relates to the field of coherent-scatter computed tomography (CSCT), where a fan-beam is applied to an object of interest. In particular, the present invention relates to a CSCT apparatus for examination of an object of interest, to a method of examining an object of interest and to a computer program for operating a CSCT apparatus.

U.S. Pat. No. 4,751,722 describes a device based on the principle of registration of an angled distribution of coherent scattered radiation within angles of 1° to 12° as related to the direction of the beam. As set forth in the U.S. Pat. No. 4,751,722, the main fraction of elastic scattered radiation is concentrated within angles of less than 12°, and the scattered radiation has a characteristic angle dependency with well marked maxima, the positions of which are determined by the irradiated substance itself. As the distribution of the intensity of the coherently scattered radiation in small angles depends on molecular structure of the substance, different substances having equal absorption capacity (which cannot be differentiated with conventional transillumination or CT) can be distinguished according to the distribution of the intensity of the angled scattering of coherent radiation typical for each substance.

Due to the improved capabilities of such systems to distinguish different object materials, such systems find more and more application in medical or industrial fields.

The dominant component of low-angle scatter is coherent scatter. Because coherent scatter exhibits interference effects which depend on the atomic arrangement of the scattering sample, coherent-scatter computed tomography (CSCT) is in principle a sensitive technique for imaging spatial variations in the molecular structure of tissues across a 2D object section.

Harding et al. “Energy-dispersive x-ray diffraction tomography” Phys. Med. Biol., 1990, Vol. 35, No. 1, 33-41 describes an energy dispersive x-ray diffraction tomograph (EXDT) which is a tomographic imaging technique based on an energy analysis at fixed angle, of coherent x-ray scatter excited in an object by polychromatic radiation. According to this method, a radiation beam is created by the use of suitable aperture systems, which has the form of a pencil and thus is also referred to as a pencil beam. Opposite to the pencil beam source, one detector element suitable for an energy analysis is arranged for detecting the pencil beam altered by the object of interest.

A coherent scatter set-up applying a fan-beam primary beam and a 2D detector in combination with CT was described in U.S. Pat. No. 6,470,067 B1. The shortcoming of the angle-dispersive set-up in combination with a polychromatic source are blurred scatter functions, which is described in e.g. Schneider et al. “Coherent Scatter Computed Tomography Applying a Fan-Beam Geometry” Proc. SPIE, 2001, Vol. 4320 754-763.

To become a competitive modality in the fields of medical imaging or non-destructive testing, the implemented reconstruction algorithm should assure both good image quality and short reconstruction times.

So far, the projection data acquired with fan-beam CSCT is reconstructed with the help for example, algebraic reconstruction techniques (ART), since ART has been shown to be highly versatile, for example, by J. A. Grant et al. “A reconstruction strategy suited to x-ray diffraction tomography” J.Opt. Soc. Am A12, 291-300 (1995).

It is an object of the present invention to provide for an improved CSCT system.

In accordance with an exemplary embodiment of the present invention as set forth in claim 1, a CSCT apparatus for examination of an object of interest is provided, comprising a source of radiation and a radiation detector ray. The source of radiation is adapted to generate a fan-shaped radiation beam during operation. According to an aspect of this exemplary embodiment of the present invention, the radiation detector ray is asymmetrically arranged with respect to the fan-shaped radiation beam.

Advantageously, this may allow to reduce the size of the radiation detector array or to use a smaller radiation detector array, which decreases a probability that detectors elements of the radiation detector array are faulty, since the probability of faulty detector elements increases with the number of detector elements provided on the radiation detector array. Furthermore, this may allow to decrease the costs of the CSCT apparatus, since smaller radiation detector arrays may be used.

For example, for a CSCT apparatus where the source of radiation and the radiation detector rotate around the object of interest around a rotation axis. Depending on the height of the scattering event—with respect to the detector plane—the distance—with respect to the plane containing the fan of primary radiation—where scattered photons can be measured on the detector may be increased. Thus, the scatter angle which may be measured may be increased.

According to another exemplary embodiment of the present invention as set forth in claim 2, the radiation detector array is arranged such that the slice plane intersects the radiation detector array at a side thereof. In particular, as set forth in the exemplary embodiment of claim 3, the radiation detector is arranged such that the slice plane intersects the radiation detector array at a portion of the radiation detector array, which is offset from the geometrical center of the radiation detector array in the scanning direction.

In other words, the radiation detector array is arranged such that the transmission fan, i.e. the radiation transmitted through the object of interest impinges on to the radiation detector array at a side thereof, where the scanner moves.

Advantageously, this may allow to firstly determine transmission data such as a transmission image and to use the transmission data or transmission image for an absorption correction for the scatter measurements. The scatter measurements relate to the measurement of radiation scattered by the object of interest out of the slice plane of the fan-beam.

According to another exemplary embodiment of the present invention as set forth in claim 4, the radiation detector ray comprises a plurality of detector lines. The fan-shaped radiation beam has a width of at least two detector lines of the plurality of detector lines, when it impinges onto the radiation detector ray after transmission through the object of interest. Due to this, a few lines of the plurality of lines measure the primary radiation transmitted through the object of interest and other lines of the plurality of detector lines provided on the radiation detector array measure the scattered radiation.

According to another exemplary embodiment of the present invention as set forth in claim 5, a first part of the radiation detector array is used for a cone beam data acquisition and a second part of the radiation detector is used for scatter radiation measurements. Advantageously, a combination of both measurements may allow for an improved image quality. Furthermore, this may allow to reduce a scanning time required to scan the object of interest.

Claims 6 to 9 provide for further exemplary embodiments of the present invention.

According to another exemplary embodiment of the present invention as set forth in claim 10, a method of examining an object of interest is provided, according to which a source of radiation is energized such that it generates a fan-shaped radiation beam. Then, a measurement of a primary radiation attenuated by the object of interest and a scatter radiation scattered by the object of interest is performed by means of a radiation detector, which is asymmetrically arranged with respect to the fan-shaped radiation beam.

Claims 11 and 12 provide for further exemplary embodiments of the method according to the present invention.

According to another exemplary embodiment of the present invention as set forth in claim 13, a computer program for operating a CSCT apparatus is provided, wherein, when the computer program is executed on a processor of the CSCT apparatus, the computer program causes the CSCT to perform steps of the method according to the present invention, as, for example, set forth in claim 10. The computer program according to the present invention is preferably loaded into a working memory of a processor of the CSCT apparatus. The computer program may be stored on a computer readable medium, such as a CD-ROM. The computer program may also be presented over a network such as the WorldWideWeb, and can be downloaded into the working memory of a data processor from such a network.

It may be seen as the gist of an exemplary embodiment of the present invention that an asymmetric acquisition system design is used in the coherent scatter computed tomography. In particular, the radiation detector array is not centered to a fan-beam plane or slice plane of the radiation beam, but is arranged asymmetrically with respect to this plane. In particular, the radiation detector array is arranged such that the primary radiation beam penetrating through the object of interest impinges onto one of the first few detector lines or the first detector line of the radiation detector array in a direction opposite to the direction along which the object of interest is displaced through the scanner, i.e. opposite to the scanning direction. First of all, this allows to increase the scatter angle range for a given detector height in the direction of the rotation axis. Secondly, when, for example, a helical data acquisition is used and the transmission fan is at the side of the detector where the scanner moves, the data flow for combined volume absorption distribution reconstruction and subsequent coherent scatter CT reconstruction is optimal. In other words, a transmission image may be generated and used for absorption correction required for coherent scatter CT reconstruction. According to an aspect of this exemplary embodiment of the present invention, the fan-shaped beam may have a width covering a plurality of detector lines when it impinges onto the radiation detector array, which allows that one part of the detector may be used for a half cone beam data acquisition and another part of the detector may, at the same time, be used for scatter measurements.

These and other aspects of the present invention will become apparent from and elucidated with reference to the embodiments described hereinafter.

Exemplary embodiments of the present invention will be described in the following, with reference to the following drawings:

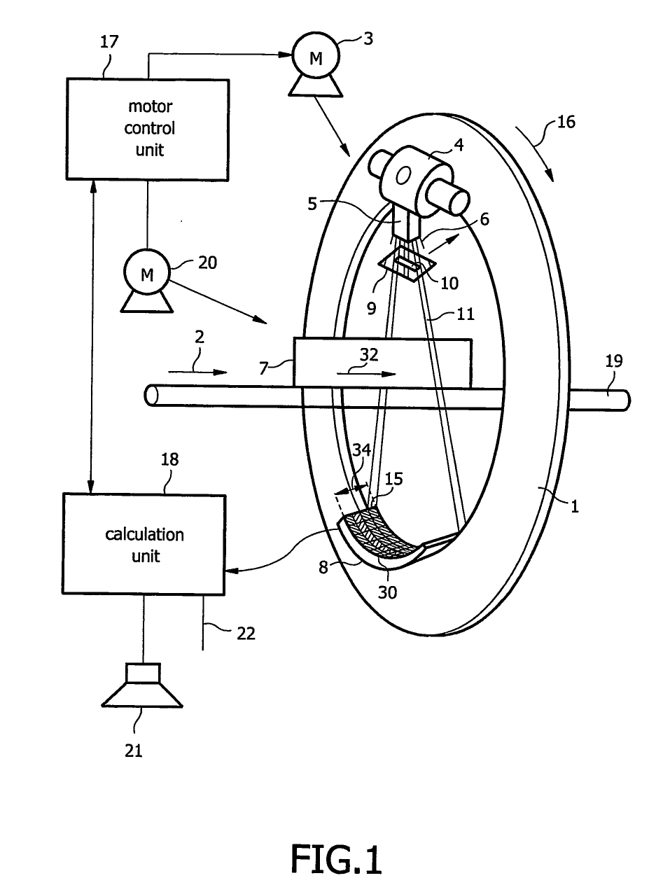

FIG. 1 shows a schematic representation of an exemplary embodiment of a computed tomograph according to the present invention.

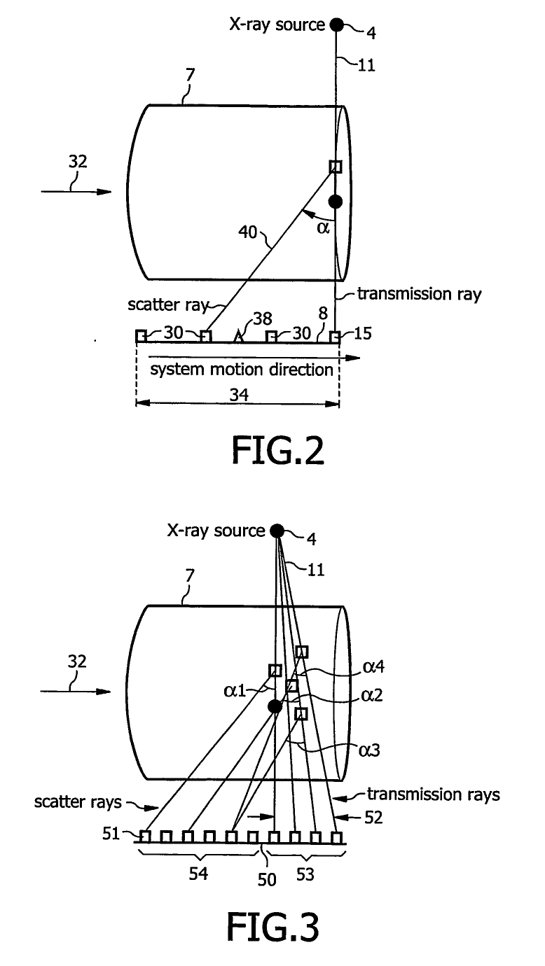

FIG. 2 shows a schematic representation of the geometry of the computed tomograph of FIG. 1.

FIG. 3 shows another schematic representation of the geometry of the computed tomograph of FIG. 1, where a fan-beam having a larger width is applied.

FIG. 1 shows an exemplary embodiment of the present invention of a computed tomograph according to the present invention. With reference to this exemplary embodiment, the present invention will be described for the application in baggage inspection to detect hazardous materials such as explosives in items of baggage. However, it has to be noted that the present invention is not limited to the application in the field of baggage inspection, but can also be used in other industrial or medical applications such as, for example, in bone imaging or discrimination of tissue types in medical applications.

The computed tomograph depicted in FIG. 1 is a fan-beam coherent scatter computed tomograph (CSCT). The computed tomograph depicted in FIG. 1 comprises a gantry 1, which is rotatable around a rotational axis 2. The gantry 1 is driven by means of a motor 3. Reference character 4 designates a source of radiation, such as an x-ray source.

Reference character 5 designates a first aperture system, which forms the radiation beam emitted from the radiation source 4 to a cone-shaped radiation beam 6. Furthermore, there is provided another aperture system 9, consisting of a diaphragm or a slit collimator. The aperture system 9 has the form of a slit 10, such that the radiation emitted from the source of radiation 4 is formed into a fan-beam 11. According to a variant of this exemplary embodiment of the present invention, the first aperture system 5 may be omitted and only the second aperture system 9 may be provided.

The fan-beam 11 is directed such that it penetrates the item of baggage 7, arranged in the center of the gantry 1, i.e. in an examination of the computed tomograph and impinges onto detector 8. As may be taken from FIG. 1, the detector 8 is arranged on the gantry 1 opposite to the radiation source 4, such that the slice plane of the fan-beam 11 intersects a row or line 15 of the detector 8. The detector 8 depicted in FIG. 1 has four detector lines 30, including the detector line 15, each comprising a plurality of detector elements. The detector lines 30 are arranged parallel to the plane of the fan-beam 11, i.e. parallel to the slice plane of the fan-beam 11 or to the fan-beam plane. The detector lines 30 are arranged parallel to each other.

It should be noted that any number of detector lines may be provided An increase of the number of detector lines 30 may reduce a scanning time.

As may be taken from FIG. 1, the detector 8 is arranged asymmetrically to the fan-beam plane of the fan-beam 11. In other words, the fan-beam 11 does not impinge onto a center of the detector 8, but impinges onto the detector 8 with an offset to the center of the detector 8. In other words, the line 15 is not the center line of the detector 8, but is a line of the plurality of detector lines of the detector 8, which is offset from the center, i.e. is arranged at a distance from the geometrical center of the detector 8. Also, it may be stated that the detector line 15 is parallel to the geometrical middle line of the detector 8, but arranged at a distance thereto.

The detector 8 is arranged such that the fan-beam 11 impinges onto the first line 15 of the detector 8 in a direction opposite to a direction 32, along which the item of baggage 7 is moved through the scanner on a conveyor belt. In other words, the detector 8 is arranged or orientate on the gantry 1 opposite to the source of radiation 4, such that the fan-beam 11 generated by the source of radiation impinges on the last detector line 15 of the detector 8 in the scanning direction 32, i.e. the direction along which the item of baggage 7 is displaced through the fan-beam plane.

Preferably, in particular when the helical data acquisition, as depicted in FIG. 1, is used and the transmission beam, i.e. the fan-beam 11, is at the side of the detector 8 where the scanning moves, a data flow for a combined volume absorption distribution reconstruction, such as, for example, described in W. A. Kalender “Computed Tomography”, ISBN 3-89578-081-1, (2000), which is hereby incorporated by reference, and subsequent coherent scatter CT reconstruction as described in EP 03100120.9 which is hereby incorporated by reference, is advantageous. Mainly, the transmission image generated from the read-outs of the detector 8 relating to the radiation attenuated by the object of interest during penetration through the object of interest may be used for a correction for the attenuation contributions in the coherent scatter CT reconstruction, where, primarily, the read-outs relating to scatter radiation scattered by the object of interest are used.

For example, according to an aspect of the present invention, the correction for the attenuation contributions on the basis of the primary radiation can be performed as follows:

In the following, the variables a and 0 denote an angular source position in relation to an x-axis in the rotation plane of the detector 8 and the source of radiation 4 and a fan-angle within the fan-beam 11 of x-rays. Furthermore, l₀ is the distance from the x-ray source to the scatter center.

The factor A(α,β,0,l₀) accounts for the attenuation of the incoming radiation along the path from the source to the point of interaction x₀. The factor B(α,β,a,l₀) is the analogous attenuation for the outgoing radiation. According to an aspect of the present invention, an assumption is made, namely that the attenuation along the path of the scattered radiation is independent of the scattering angle and equal to the attenuation of the residual primary beam B(α,β,a,l₀)=B(α,β,0,l₀). This assumption is only made when the absorption values in the volume are not known. In the case of a helical acquisition including a previous transmission reconstruction, the attenuation of the primary beam is known and may be used for a direct calculation of B(α,β,a,l₀).

This holds true for small scatter angles, i.e. scatter angles in the approximate range of 0° to 5°. Also, this holds true for ideal spatial resolution and not too strong variations of the attenuation along the z direction. For an attenuation correction, the transmitted intensities Iₜᵣₐₙₛ and the detector elements of the central plane (i.e. the primary radiation detector; detector line 15), in case of a simple transmission CT, are taken into account:
Iₜᵣₐₙₛ(α,β,0,l₀)=I₀(α,β,0)A(α,β,0,l₀)×B(α,β,0,l₀)E_{CT}(α,β,0)

with the intensity I₀ of the incoming radiation and a constant geometrical efficiency E_{CT}(α,β,0)=A/G². Here G and A denote the distance from the x-ray source to the focus-centered detector and the area of a single detector element, respectively.

This leads to the scatter projection data P_{D}(α,β,a) as input for the reconstruction algorithm according to U. van Stevendaal et al., “A reconstruction algorithm for coherent scatter computed tomography based on filtered back-projection” (Med. Phys. 30, 9, Sep. 2003),

$$\begin{matrix}{P}_{D} ( α , β , a ) = \frac{{\int }_{0}^{G} {I}_{coh} ( α , β , a , {l}_{0} ) ⅆ {l}_{0}}{{\int }_{0}^{G} {I}_{trans} ( α , β , 0 ) ⅆ {l}_{0}} \\ = {\int }_{0}^{G} {\vert F ( α , β , a , {l}_{0} ) \vert}^{2} ξ ( α , β , a , {l}_{0} ) ⅆ {l}_{0}\end{matrix}$$

with the overall efficiency ξ(α,β,a,l₀)=

$${E}_{eff} ( α , β , a , {l}_{0} ) / {E}_{CT} ( α , β , 0 ) or$$

$$ξ ( α , β , a , {l}_{0} ) = \frac{{G}^{2} ( G - {l}_{0} )}{{( {h}^{2} + {( G - {l}_{0} )}^{2} )}^{3 / 2}} ,$$

where E_{eff}(α,β,a,l₀) is the geometrical efficiency factor for an off-plane detector element.

Advantageously, the projection data of coherently scattered x-rays may be corrected concerning the attenuation contribution. Furthermore, an overall efficiency is introduced in order to weight the projection data more accurately.

The detector 8, which, as may be taken from FIG. 1, may be a detector array, consisting of a plurality of detector lines, consisting of a plurality of scintillator cells.

The apertures of the apertures systems 5 and 9 are adapted to the dimensions of the detector 8, such that the scanned area of the item of baggage 7 is within the fan-beam 11 and that the detector 8 covers the complete scanning area in fan direction. Advantageously, this allows to avoid unnecessary excess radiation applied to the item of baggage 7. During a scan of the item of baggage 7, the radiation source 4, the apertures systems 5 and 9 and the detector 8 are rotated along the gantry 1 in the direction indicated by arrow 16. The rotation of the gantry 1 with the source of radiation 4, the aperture systems 5 and 9 and the detector 8, the motor 3 is connected to a motor control 17, which is connected to a calculation unit 18.

In FIG. 1, the item of baggage 7 is disposed on the conveyor belt 19. During the scan of the item of baggage 7, while the gantry rotates around the item of baggage 7, around the rotation axis 2, defining a rotation plane, the conveyor belt 19 displaces the item of baggage 7 along the scanning direction 32, parallel to the rotation axis 2 of the gantry 1. By this, the item of baggage 7 is displaced through the fan-beam 11, i.e. through the slice plane. Furthermore, by the combined movement of the gantry 1 and the item of baggage 7 on the conveyor belt 19, the item of baggage 7 is scanned along a helical scan path. The conveyor belt 19 may also be stopped during the scans to thereby measure single slices.

The detector 8 is connected to a calculation unit 18. The calculation unit 18 receives the detection results, i.e. the read-outs from the detector elements of the detector 8 and determines a scan result on the basis of the scanning results from the detector 8, i.e. from the detector lines 30.

In the arrangement depicted in FIG. 1, the detector line 15 measures the primary radiation attenuated by the object of interest, i.e. by the item of baggage 7. The remaining detector lines 30 measure scatter radiation, i.e. radiation scattered by the item of baggage 7 out of the fan-beam plane 11. Thus, the detector line 15 measures the primary radiation, i.e. the attenuation caused by the item of baggage 7, whereas the remaining three detector lines measure the scatter radiation scattered from the item of baggage 7. Furthermore, the calculation unit 18 is adapted to communicate with the motor control unit in order to coordinate the movement of the gantry 1 with the motors 3 and 20 or with the conveyor belt 19.

The calculation unit 18 may furthermore be adapted for the detection of explosives in the item of baggage 7 on the basis of the read-outs from the detector 8. This may be made automatically by reconstructing scatter functions from the read-outs of the detector lines and comparing them to tables including characteristic measurement values of explosives determined during preceding measurements. In case the calculation unit 18 determines that the measurement values read-out from the detector 8 match with characteristic measurement values of an explosive, the calculation unit 18 automatically outputs and alarm via a loudspeaker 21.

Advantageously, the arrangement depicted in FIG. 1 may allow—for a given detector height—in the direction of the rotation axis 2, i.e. for a given number of detector lines 30 having a given width, to significantly increase a scatter angle a detectable by the scanner. The scatter angle a is defined as the angle between a ray of the fan beam 11 impinging onto detector line 15, i.e. the plane of the primary radiation and a scatter ray caused by a scattering of the radiation in the item of baggage 7. This may further be taken from FIGS. 2 and 3.

Furthermore, the arrangement where a helical data acquisition is used, as in FIG. 1, and where the transmission fan, i.e. fan beam 11 impinges onto the side of the 25 detector when the scanner moves, the data flow for a combined volume absorption distribution reconstruction and subsequent coherent scatter CT reconstruction is optimal. This is due to the fact that the transmission image determined from the primary transmission may be generated before further computations with the scatter radiation such that the transmission image may be used for the absorption correction as described 30 above.

The operation which may be performed with the CSCT scanner depicted in FIG. 1 and, in particular, calculations which may be performed with the calculation unit 18, are further described in the following with reference to FIGS. 2 and 3. In the subsequent description of FIGS. 2 and 3, the same reference numerals as in FIG. 1 are used to designate the same or corresponding elements in FIGS. 2 and 3.

FIG. 2 shows a simplified schematic representation depicting a geometry of the CSCT scanner of FIG. 1 for further explaining the present invention.

As depicted in FIG. 2, a transmission ray emitted by the x-ray source 4 (the aperture systems 5 and 9 were omitted for the sake of clarity) penetrates the item of baggage 7 and goes through the item of baggage 7 and eventually impinges onto line 15 of the detector 8 (FIG. 2 shows a cross-sectional side view). The attenuated transmission ray is measured by detector line 50, which, as may be seen from FIG. 2, is the first detector line of the detector 8 seen in a direction opposite to the scanning direction 32 and perpendicular to the extension of the lines 15 and 30. However, as may also be taken from FIG. 2, a portion of the fan beam 11 penetrating the item of baggage 7 is scattered in the item of baggage 7 out of the fan beam plane 11. The scatter ray is designated with reference numeral 40. A scatter angle a is defined as the angle between the scatter ray 40 and the transmission ray in the fan beam plane 11. The scatter ray 40 impinges onto a portion of the detector 8, which is referred to as scatter radiation detector and which does not measure the rays directly transmitting through the item of baggage 7. The scatter radiation detector lines may be provided with lamellae.

Advantageously, as obvious from FIG. 2, considering a detector 8 having a given height in the direction of the rotation axis or a given number of detector lines 30 and 15, the range of the scatter angle αmay be significantly increased in comparison to the case where the detector 8 is arranged symmetrically to the transmission ray in the fan beam 11.

Furthermore, as may also be taken from FIG. 2, since the transmission ray or the transmission fan is measured at the first line 15 of the detector 8, seen in the direction opposite to the system motion direction or scanning direction 32, the transmission image may be generated for performing the absorption correction in the subsequent coherent scatter CT reconstruction.

It should be noted that, according to the present invention, the detector line 15 does not need to be the first line in the direction opposite to the scanning direction, or the last line seen in the scanning direction 32. According to the present invention, the detector 8 should be arranged such that the transmission ray or the fan beam plane 11 intersects the detector 8 with an offset to a geometrical center line of the detector 8. The geometrical center line of detector 8 is denoted by reference numeral 38 in FIG. 2.

FIG. 3 shows another schematic representation of another geometry as it may be implemented in the CSCT scanner depicted in FIG. 1. FIG. 3 shows a cross-sectional view of the detector 50.

As may be taken from FIG. 3, a detector 50 is provided, having a plurality of detector lines 51. The detector 50 is asymmetrically arranged with respect to the fan beam 11, such that detector lines 51 in a portion 53 of the detector line, detect the direct transmission rays of the primary radiation transmitted through the object of interest or item of baggage 7, whereas detector lines 51 on a second portion of the detector 15 detect a scatter radiation scattered out of the fan plane by the item of baggage 7.

Furthermore, as may be taken from FIG. 3, the aperture systems 5 and 9 (omitted in FIG. 3 for the sake of simplicity and clarity), where adapted such that a fan beam 11 is generated, having a size such that it covers a plurality of detector lines 51 in the portion 53 of the detector 50 when it impinges onto the detector 50. This width is denoted with reference numeral 52 in FIG. 3.

Advantageously, such an arrangement may be used in a way that the line 51 in the first portion 53 of the detector is used for a half cone beam data acquisition, and the detector lines 51 in the second portion 54 of the detector 50 are at the same time used for scatter measurements. Advantageously, this may allow for an improved image quality and, furthermore, may allow for a reduction of scanning time.

1. CSCT apparatus for examination of an object of interest, the CSCT apparatus comprising: a source of radiation; and a radiation detector array; wherein the source of radiation is adapted to generate a fan-shaped radiation beam; wherein the radiation detector array is asymmetrically arranged with respect to the fan-shaped radiation beam.

2. The CSCT apparatus of claim 1, wherein the radiation beam penetrates the object of interest in a slice plane; wherein the radiation detector array is arranged such that the slice plane intersects the radiation detector array at a side thereof.

3. The CSCT apparatus of claim 2, wherein the object of interest is displaced with respect to the slice plane along a scanning direction which intersects the slice plane at an angle; wherein a location where the slice plane intersects the radiation detector array is offset with respect to a geometrical center of the radiation detector array; wherein the location is offset from the geometrical center in the scanning direction.

4. The CSCT apparatus of claim 1, wherein the radiation detector array comprises a plurality of detector lines; wherein the fan-shaped radiation beam has a width of at least two detector lines of the plurality of detector lines when it impinges onto the radiation detector array after transmission through the object of interest.

5. The CSCT apparatus of claim 4, wherein a first part of the radiation detector array is used for a cone beam data acquisition and a second part of the radiation detector is used for scatter radiation measurements.

6. The CSCT apparatus of claim 1, wherein the source of radiation and the radiation detector array are rotatable around a rotational axis extending through an examination area for receiving the object of interest; wherein the source of radiation is arranged opposite to the source of radiation during scanning; wherein the source of radiation generates a fan-shaped x-ray beam adapted to penetrate the object of interest in the examination area in a slice plane; wherein the radiation detector includes a plurality of detector lines each with a plurality of detector elements arranged in a line; wherein the plurality of detector lines are arranged parallel to the slice plane; wherein a primary radiation attenuated by the object of interest impinges on a first line of the plurality of detector lines; wherein the first line is not a second line of the plurality of detector lines; wherein the second line is extending close to the geometrical center of the radiation detector array.

7. The CSCT apparatus according to claim 5, wherein the first line is arranged with at a distance from the first line in a direction along which the object of interest is displaced with respect to the radiation detector array during scanning.

8. The CSCT apparatus of claim 5, wherein a third line of the plurality of detector lines measures a scatter radiation scattered from the object of interest; and wherein the third detector line is offset from the first detector line in a direction along which the object of interest is displaced with respect to the radiation detector array during scanning.

9. The CSCT apparatus of claim 5, wherein the first line is the last line of the radiation detector array in the direction along which the object of interest is displaced with respect to the radiation detector array.

10. Method of examining an object of interest, the method comprising the steps of energizing a source of radiation such that it generates a fan-shaped radiation beam; and measuring a primary radiation attenuated by the object of interest and a scatter radiation scattered by the object of interest by means of a radiation detector array which is asymmetrically arranged with respect to the fan-shaped radiation beam.

11. The method of claim 10, wherein the radiation beam penetrates the object of interest in a slice plane; wherein the radiation detector array is arranged such that the slice plane intersects the radiation detector array at a side thereof; wherein the object of interest is displaced with respect to the slice plane along a scanning direction which intersects the slice plane at an angle; wherein a location where the slice plane intersects the radiation detector array is offset with respect to a geometrical center line of the radiation detector array; wherein the location is in the scanning direction at a distance from the geometrical center line.

12. The method of claim 10, wherein the radiation detector array comprises a plurality of detector lines; wherein the fan shaped radiation beam has a width of at least two detector lines of the plurality of detector lines when it impinges onto the radiation detector array after transmission through the object of interest such that a first part of the radiation detector array is used for a cone beam data acquisition and a second part of the radiation detector is used for scatter radiation measurements.

13. Computer program for operating a CSCT apparatus, wherein, when the computer program is executed on a processor of the CSCT apparatus, the computer program causes the CSCT apparatus to perform the following operation: energizing a source of radiation such that it generates a fan-shaped radiation beam; and measuring-a primary radiation attenuated by the object of interest and a scatter radiation scattered by the object of interest by means of a radiation detector array which is asymmetrically arranged with respect to the fan-shaped radiation beam.
